(19) United States
(12) Patent Application Publication
(10) Pub. No.: US 2009/0098366 A1
(43) Pub. Date: Apr. 16, 2009

(54) Methods of coating surfaces with nanoparticles and nanoparticle coated surfaces

(75) Inventors: Stoyan K. Smoukov, Raleigh, NC (US); Kyle J.M. Bishop, Evanston, IL (US); Bartlomiej Kowalczyk, Piaseczno (PL); Alexander M. Kalsin, Izhevsk (RU); Bartosz A. Grzybowski, Evanston, IL (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Northwestern University, Evanston, IL (US)

(21) Appl. No.: 12/230,902

(22) Filed: Sep. 8, 2008

Related U.S. Application Data
(60) Provisional application No. 60/970,689, filed on Sep. 7, 2007.

(51) Int. Cl. B32B 5/16; B05D 1/04

(52) U.S. Cl. 428/328; 427/458; 427/470; 428/323

(57) ABSTRACT

Solutions containing oppositely-charged nanoparticles (NPs) deposit “patchy” coatings of alternating charge distribution on various types of materials, including polymers, elastomers, and semiconductors. Surface adsorption of the NPs is driven by cooperative electrostatic interactions and does not require chemical ligation or layer-by-layer schemes. The composition and the quality of the coatings can be regulated by the types, charges, and the relative concentrations of the NPs used and by the pH. Dense coatings can be formed on flat, curvilinear, or micropatterned surfaces. The coatings are stable against common chemicals for prolonged periods of time, and can be used in applications ranging from bacterial protection to plasmonics.

This application claims the benefit of Provisional U.S. Patent Application Ser. No. 60/970,689, filed on Sep. 7, 2007, which is incorporated by reference herein in its entirety.

### FIELD OF THE INVENTION

The present invention relates generally to the formation of nanoparticle coatings on substrate surfaces.

### BACKGROUND

Coatings composed of or containing various types of nanoscopic particles, for example, fluorescent (CdS, CdSe) [1, 2], metallic (Au, Ag, Cu) [3-5], or polymeric (polystyrene) [6], have recently attracted considerable scientific attention due to their potential applications in corrosion protection [7], crack-resistant electrodes [8], heterogeneous catalysis [9], antireflective films [10], displays [11], and substrates for cell adhesion [12]. Although nanoparticles (NPs) can be tethered onto surfaces by a variety of chemical ligation schemes [13-15], through NP electrodeposition [16, 17], Langmuir-Blodgett [18], or sol-gel [19] techniques, these methods generally require substrate-specific procedures and are sometimes limited to coatings containing NPs of one type. Preparation of multicomponent, all-nanoparticle coatings on different types of materials remains challenging and has so far been limited to layer-by-layer schemes, in which layers of oppositely-charged NPs are sequentially deposited onto the substrate [20].

### SUMMARY

According to a first embodiment, a method is provided which comprises:

contacting a surface of a substrate with an aqueous solution comprising first nanoparticles having positively charged moieties on a surface thereof and second nanoparticles having negatively charged moieties on a surface thereof; and

adsorbing the first and second nanoparticles onto the surface to form an adsorbed nanoparticle coating on the surface of the substrate.

According to a second embodiment, an article of manufacture is provided which comprises:

a substrate comprising a surface; and

one or more nanoparticle monolayers on the surface,

wherein the one or more nanoparticle monolayers each comprise first nanoparticles having positively charged moieties on a surface thereof and second nanoparticles having negatively charged moieties on a surface thereof and wherein the first and second nanoparticles are adsorbed onto the surface of the substrate.

These and other features of the present teachings are set forth herein.

### BRIEF DESCRIPTION OF THE DRAWINGS

The drawings described below are for illustration purposes only. The drawings are not intended to limit the scope of the present teachings in any way. The patent or application file contains at least one drawing executed in color. Copies of this patent or patent application publication with color drawing(s) will be provided by the Office upon request and payment of the necessary fee.

FIG. 1 is a schematic illustrating the precipitation of oppositely-charged nanoparticles monitored by UV-Vis spectroscopy.

FIG. 2 is a schematic illustrating a method of forming a nanoparticle (NP) coating on a substrate.

FIG. 3 is an SEM image of an AgTMA-AuMUA NP coating formed on Si.

FIG. 4 is a picture of a PPMA cuvette which has not been exposed to an NP coating solution (left); a PPMA cuvette which has been immersed in an NP coating solution for 1 hr but which has not been oxidized prior to immersion (middle); and a PPMA cuvette which has been plasma-oxidized and then immersed for 1 hr in an NP coating solution (right).

FIG. 5 is a graph showing absorption of AgTMA-AuMUA coatings (λₘₐₓ=557-561 nm) for single and multiple exposures (i.e., one, three and five times) to an NP coating solution.

FIG. 6 is an SEM image of a typical coating formed on oxidized Si from a pH=7 solution containing oppositely charged NPs (i.e., AgTMA and AuMUA).

FIG. 7 is a bar chart showing absorbance values of various coated substrates: AgTMA-AuMUA coating (left bar); a coating deposited from a solution containing only positively charged silver NPs (middle bar); and a coating deposited from a solution containing only negatively charged gold NPs (right bar).

FIG. 8A is an SEM image of a coating deposited from a solution containing only positively charged silver NPs.

FIG. 8B is an SEM image of a coating deposited from a solution containing only negatively charged gold NPs.

FIG. 8C is an SEM image of an AgTMA-AuMUA coating formed from a pH=4 NP coating solution.

FIG. 8D is an SEM image of an AgTMA-AuMUA coating formed from a pH=10 NP coating solution.

FIG. 9 is a UV-Vis spectra of glass slides coated from solutions containing different proportions of AuMUA and AgTMA NPs, 1:1, 2:1, and 1:2.

FIGS. 10A and 10B are an SEM image (FIG. 10A) and an XPS spectrum (FIG. 10B) from a AuMUA/AgTMA coating prepared from solution containing a 20% excess of AgTMAs.

FIGS. 11A and 11B are an SEM image (FIG. 11A) and an XPS spectrum (FIG. 11B) from a AuMUA/AgTMA coating prepared from solution containing a 60% excess of AuMUAs in solution.

FIGS. 12A and 12B are an SEM image (FIG. 12A) and an XPS spectrum (FIG. 12B) for NP coatings comprising AgMUA/AgTMA NPs.

FIGS. 13A and 13B are an SEM image (FIG. 13A) and an XPS spectrum (FIG. 13B) for NP coatings comprising AuMUA/AgTMA NPs.

FIGS. 14A and 14B are an SEM image (FIG. 14A) and an XPS spectrum (FIG. 14B) for NP coatings comprising AuTMA/AgTMA/PdMUA NPs.

FIG. 15A is a picture of an uncoated glass vial (left) and a glass vial coated with AuMUA/AgTMAs (right).

FIG. 15B is an SEM image of a corner of a 1 μm line pattern (750 nm deep) in oxidized PDMS covered with NPs wherein the inset shows a large-area SEM image.

FIG. 15C is an optical micrograph of ZnO microstructured with 10 μm lines by ASoMic [47-49] and then coated with NPs.

FIGS. 16A and 16B is a picture of AgTMA/AgMUA coated glass and AgTMA/AgMUA coated PDMS disks and control disks exposed to gram-positive (S. Aureus) bacteria (FIG. 16A) and gram-negative (E. Coli) bacteria (FIG. 166B).

FIGS. 17A and 17B are pictures showing Rat-2 cells on glass (FIG. 17A) and on an antibacterial AgNP coating (FIG. 17B).

FIG. 18 is a picture of glass pieces coated with AgTMA/AuMUA (the two purple vials on the left) and with AgTMA/AgMUA (the two orange vials on the right) wherein, in each pair of vials, the darker vial is dry and the lighter vial is wet.

FIG. 19 is an absorbance spectra wherein the curve with the shorter absorbance maximum is that of a dry, coated vial and wherein the inset shows reversible shifts of the absorption maximum over nine wetting/drying cycles.

FIG. 20 illustrates a periodic simulation cell (“reservoir”) of dimensions 1 μm×1 μm×1 μm in equilibrium (i.e., at constant chemical potential, μ, and temperature, T) with a smaller cell (typically, 150 nm×150 nm×150 nm) with the substrate at the z=0 plane wherein the red spheres denote positively charged TMA NPs and the blue spheres denote negatively charged MUA NPs.

FIGS. 21A and 21B are graphs showing calculated electrostatic (ES), van der Waals (vdW), and hydrogen bond (HB) potentials at pH=7 for two spheres (FIG. 23A) and for a sphere and surface (FIG. 23B) as a function of their separation wherein the arrows give the magnitudes of the various types of interactions at contact.

FIG. 22A is a schematic illustrating a dense NP coating obtained from an equimolar mixture of positive and negative NPs at pH=7.

FIG. 22B is a schematic illustrating a sparse NP coating from a solution of positively charged NPs at pH=7.

FIG. 22C is a schematic illustrating an NP coating at a pH=4.

FIG. 22D is a schematic illustrating an NP coating at a pH=10.

FIG. 23A is a computer simulation of the formation of multiple layers of NPs wherein, in layer 1, the bare substrate is first equilibrated with the NP coating solution and all NPs within 1.25 particle diameters from the surface are then fixed in place approximating the experimental process of drying and wherein the procedure is repeated sequentially to yield coatings of increasing thickness.

FIG. 23B is a graph showing the number of NPs deposited per unit increasing linearly with the number of deposition cycles.

FIGS. 24A and 24B are an SEM and a schematic, respectively, illustrating that negatively charged NPs do not adsorb onto oxidized surfaces presenting residual negative charge.

FIGS. 25A and 25B are an SEM and a schematic, respectively, illustrating that positively charged NPs give only very sparse coatings (˜5% surface coverage) due to the repulsions between adsorbed particles.

FIGS. 26A and 26B are an SEM and a schematic, respectively, illustrating that mixtures of positively and negatively charged nanoparticles adsorb cooperatively and yield dense coatings (˜70% surface coverage) wherein the scale bar for is 200 nm.

FIG. 27 is a picture of various NP coatings illustrating that coatings composed of only silver NPs (e.g., AgMUA and AgTMA) appear orange while those comprising gold and silver particles (e.g., AuMUA and AgTMA) are violet in appearance.

FIGS. 28A and 28B are pictures illustrating that AgNP deposited onto a range of supports inhibit growth of E. coli (FIG. 28A) and S. aureus (FIG. 28B) wherein pronounced zones of inhibition can be seen around the coated disks but not around un-coated glass controls, wherein all disks are 10 mm in diameter and wherein the pictures were taken 16 hrs after plating the bacteria.

FIGS. 29A and 29B are pictures showing a comparison of the antibacterial properties of all-silver, AgMUA/AgTMA, and gold-silver, AuMUA/AuTMA, coatings for both E. Coli (FIG. 29A) and S. Aureus (FIG. 29B) wherein it can be seen that the zones of inhibition are more pronounced for the all-silver coatings and wherein the disks are 10 mm in diameter and the pictures were taken 16 hrs after plating the bacteria.

FIGS. 30A and 30B are schematics illustrating a selective precipitation method in which the addition of dithiols (red arcs) causes crosslinking and aggregation of AgNPs (larger, gray circles) but not of Ag⁺ ions (smaller, brown circles) wherein the ions remaining in solution can be determined by ICP-MS.

FIG. 31 is a graph of the percentage of Ag⁺ cations released from Ag NPs as a function of time (i.e., days) showing that the nanoparticles “leak” the cations at an approximately constant rate.

FIGS. 32A-32D are photographs showing coatings formed from mixture of oppositely charged NPs on Tygon® tubing (FIG. 32A); pipette tips (FIG. 32B); glass vials (FIG. 32C); and syringes (FIG. 32D) wherein the purple color corresponds to Ag(+)/Au(−) NP coating, the yellow color corresponds to Ag(+)/Ag(−) and wherein in each picture the transparent (uncoated) sample is shown as a reference.

### DETAILED DESCRIPTION

The present invention provides a conceptually different and versatile approach to multicomponent coatings, in which nanoparticles (e.g., metal-core nanoparticles) of the same or different type and of opposite charges are interspersed within each deposited NP monolayer. The coatings can be plated from aqueous solutions containing charged nanoparticles. Remarkably, while positively-charged and negatively-charged particles alone only minimally adsorb onto the substrates, their mixtures adsorb cooperatively and deposit layers stabilized by favorable electrostatic interactions between oppositely charged NPs and by residual hydrogen bonding and van der Waals interactions between the particles and the substrate. Cooperative adsorption occurs readily onto a variety of materials (glasses, polymers, elastomers, and semiconductors) and gives coatings whose elemental composition (including Au, Ag, Pd, and their combinations) and density can be regulated by the composition and the pH of the coating solution. The coatings are stable in common solvents and can be used in applications ranging from antibacterial protection to plasmonics. The practically appealing features of this system are its simplicity and generality, ability to coat large areas and non-planar surfaces (including micropatterned ones), flexibility in tailoring surface composition, high degree of control over the coatings' thickness, and the re-usability of the plating solutions.

The present invention provides methods for forming single or multiple layers of nanoparticles (NPs) on a variety of substrates. The methods involve exposing an uncoated substrate or a dry, previously NP coated substrate to a NP coating solution comprising charged NPs. The pH of the NP coating solution, the ratio of positively to negatively charged NPs in the coating solution and the metal core of the charged NPs may vary, resulting in coatings having different metal compositions and NP surface coverages. The NP coated substrates may be used in a variety of applications including bacterial protection and plasmonics.

The present invention provides methods for forming nanoparticle (NP) coatings on substrates. The methods can provide substrates uniformly coated with a single monolayer of NPs as well as substrates coated with multiple layers of NPs.

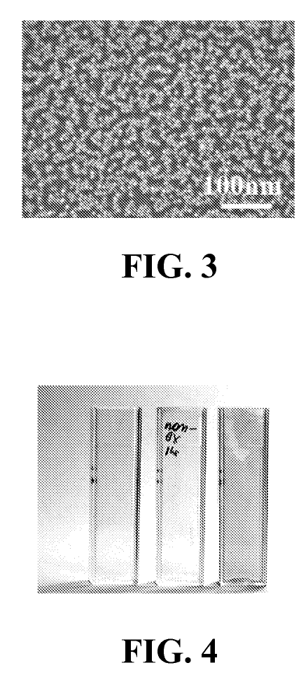

As depicted schematically in FIG. 2, the method for forming a NP coating on a substrate involves exposing the substrate to a NP coating solution comprising charged NPs. In some embodiments, the method includes the step of oxidizing the substrate prior to exposing the substrate to the NP coating solution. In other embodiments, the method includes the step of drying the coated substrate. A single exposure to or “dip” into a NP coating solution may result in a substrate coated with a single monolayer of NPs as shown in FIG. 3 and FIG. 4.

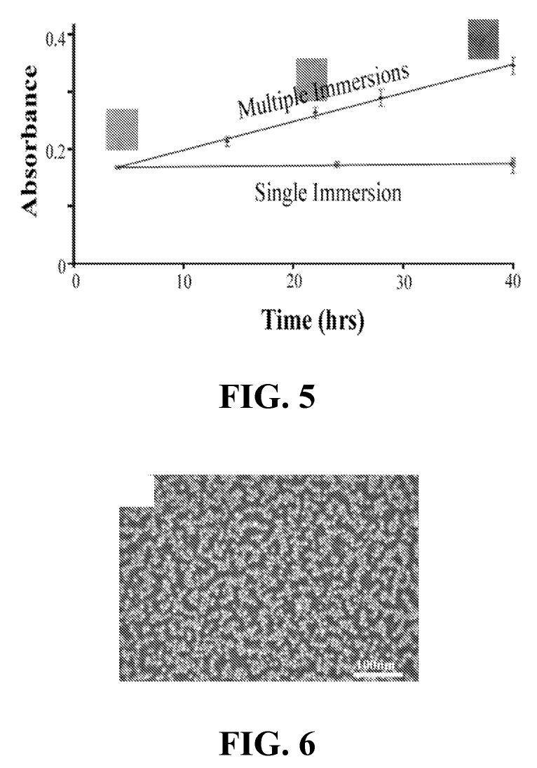

Additional exposures of a previously NP coated substrate to a NP coating solution may result in a substrate coated with multiple layers of NPs. In this embodiment, a dry, NP coated substrate is exposed to a NP coating solution comprising charged NPs. Deposition of multiple layers of NPs requires that the NP coated substrate be dry prior to further exposure to the NP coating solution. Substrates coated with multiple layers of NPs are shown in FIG. 5. Once formed, the coating persists on the substrate surface and there is no need for drying it. To get more stable/thicker coating it should be dried/and soaked again. The soaking time needed to coat a material surface in the NP solution can be a few minutes up to two or three hours, depending on the concentration of the NPs in solution. The charged moieties can be omega-substituted and can include the following charged groups, COO⁻, (SO₃)⁻, (PO₄)²⁻, [N(Alk)₃]⁺, [N(Aryl)₃]⁺, but are not limited to these. Since the mechanism of adsorption is not dependent on the chain length, from C₂ up to C₂₄ or even longer chains can be used. The substrate surface to be coated with NPs can be of any material which has or can form a charged surface in water (e.g., a metal, a substance with a surface oxide layer, semiconductor, glass, ceramics, plasma oxidized polymer, or wood). The shape and size of the object to coat is not limiting and can range from very large in size (e.g., centimeters or greater) to micron size. Any NP particle size that forms a stable solution of oppositely charged NPs can be used. The thiol chain length and the NP material can affect the stability of the solution. The NPs can have a size (e.g., diameter) of 1-20 nm.

The NP coating solutions of the present invention comprise charged NPs. A variety of NPs may be used including but not limited to gold (Au), silver (Ag), platinum (Pt), copper (Cu) and palladium (Pd) NPs. Semiconductor NPs can also be used. Techniques for forming NPs are well known in the art [21, 22]. Positively and negatively charged NPs may be formed by covering the NPs with an appropriate compound. For example, positive charges may be introduced onto NPs by covering them with a self-assembled monolayer (SAM) of N,N,N-trimethyl(11-mercaptoundecyl)-ammonium chloride (TMA). Similarly, negative charges may be introduced by covering NPs with mercaptoundecanoic acid (MUA). Methods for forming charged NPs and for forming NP coating solutions from the charged NPs are well known and are described in more detail in the examples provided below [22-26].

The ratio of the positively charged NPs to negatively charged NPs in the NP coating solutions may vary. In some embodiments, the NP coating solution comprises a substantially equal number of positively and negatively charged NPs. In other embodiments, there is an excess of positively charged NPs and in yet other embodiments, there is an excess of negatively charged NPs. In still other embodiments, the NP coating solution comprises only positively charged NPs. The ratio of positively to negatively charged NPs influences the density of the NPs adsorbed to the surface of the substrate. As shown in FIG. 8B, there is substantially no NP adsorption onto oxidized substrates results from NP coating solutions comprising only negatively charged NPs. However, as shown in FIG. 8A, some NP adsorption results from NP coating solutions comprising only positively charged NPs. As shown in FIGS. 3, 6 and 9, NP surface coverage is maximized when the NP coating solution comprises substantially equal numbers of positively and negatively charged NPs.

The NP coating solutions may comprise charged NPs having cores of the same or different material (e.g., metal). In some embodiments, the charged NPs in the coating solution will comprise the same metal core. For example, a NP coating solution may comprise only charged Ag NPs, as shown in FIGS. 12A and 12B. In other embodiments, the NP coating solution may comprise charged NPs having different metal cores. For example, an NP coating solution may comprise charged Ag NPs, Au NPs and Pd NPs as shown in FIGS. 14A and 14B. Thus, the methods of the present invention provide multicomponent NP coatings, i.e., coatings comprising more than one type of metal NP.

The pH of the NP coating solutions may vary. In some embodiments, the pH of the NP coating solution is about 7. In other embodiments, the pH solution may be more acidic or more basic. For example, the pH of the solution may be as low as 4 or as high as 10. The pH of the NP coating solutions also influences the density of the NPs adsorbed to the surface of the substrate. As shown in FIG. 6 and in FIGS. 8C and 8D, NP adsorption is maximized when the pH of the coating solution is adjusted close to neutral (FIG. 6) while adsorption decreases at more acidic (FIG. 8C) and basic (FIG. 8D) pHs.

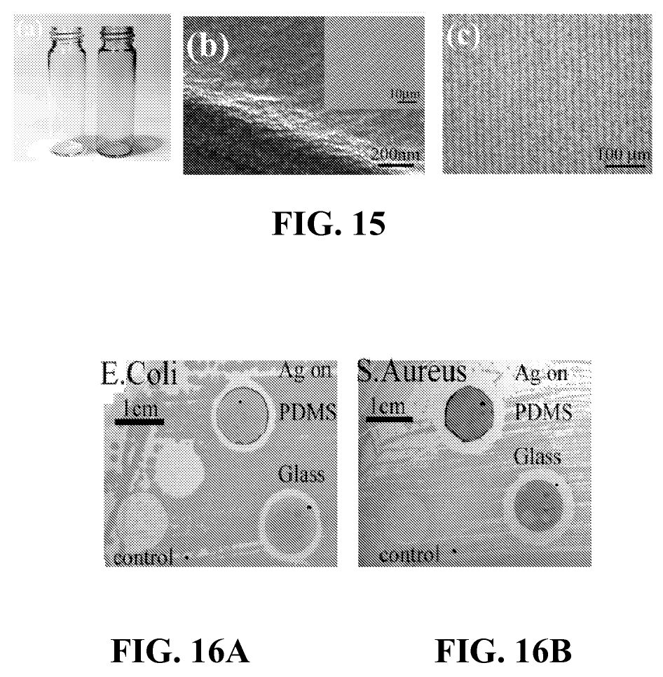

The methods of the present invention may be used to coat a variety of substrates. Suitable substrates include, but are not limited to, borosilicate glass, poly(dimethyl siloxane), polystyrene, polyethylene, poly(methyl methacrylate) (PMMA), polyester, PET/PETG copolymer, silicon, GaAs and ITO. Substrates may be planar or non-planar. For example, as shown in FIG. 15A, the methods may be used to coat cylindrical glass vials with NPs. The substrates may also comprise microstructures as shown in FIGS. 15B and 15C. The substrates used in the present invention may be oxidized prior to coating with NPs.

The coating methods of the present invention also provide a significant practical advantage. Because each coating step involving exposure of a substrate to a NP coating solution removes roughly equal amounts of positively and negatively charged NPs, the composition of the coating solution remains unchanged. Therefore, NP coating solutions may be used in multiple deposition cycles onto the same or different substrates saving time, materials and cost.

The NP coatings provided by the present invention exhibit a number of characteristics. As illustrated in FIGS. 3, 6, 10A and 11A, NP monolayers adsorbed to the surface of substrates can be uniformly “patchy.” By “patchy,” it is meant that the NPs adsorb in patches on the surface of the substrate, leaving areas of uncoated substrate. However, the NP patches and uncoated areas can be uniformly distributed on the surface of the substrate. Both the size of the NP patches and the areas of uncoated substrate may vary in size, depending upon the composition and pH of the NP coating solution. In some embodiments, the size of the NP patches and uncoated areas are on the order of tens of nanometers. By contrast, NP coatings comprising multiple layers of NPs are less patchy as additional NPs adsorb to the areas of uncoated substrate between existing NP patches.

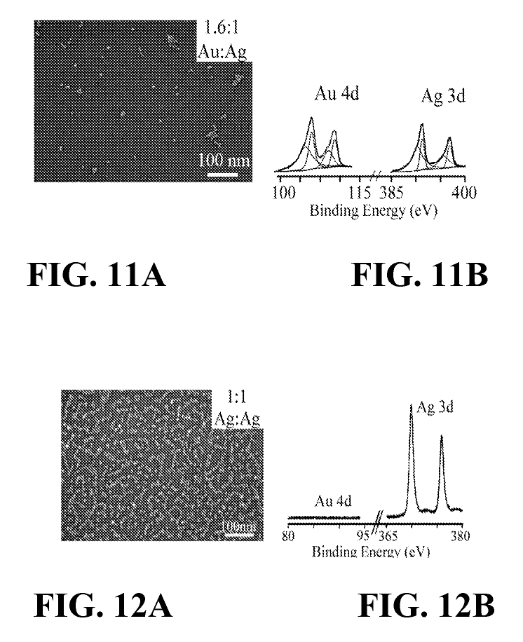

In addition, as shown in FIGS. 10 and 11, the disclosed methods provide substrates coated with substantially equal proportions of positively and negatively charged NPs, irrespective of the proportion of positively and negatively charged NPs in the NP coating solutions.

Finally, despite inherent water solubility of the constituent NPs and the lack of their covalent attachment to the substrates, the deposited NP monolayers and multilayers are stable against prolonged (i.e., for weeks) soaking in DI water and also in salt solutions (e.g., KCl) up to 1M. The NP coatings are also stable in acetone, methanol, 0.2 M HCl and dilute bases (e.g., 0.02 M NMe₄OH) for at least 48 hours. However, the coatings may disintegrate rapidly when exposed to concentrated acids (e.g., >1 M HCl) or bases (e.g., 0.2 M NaOH or NMe₄OH).

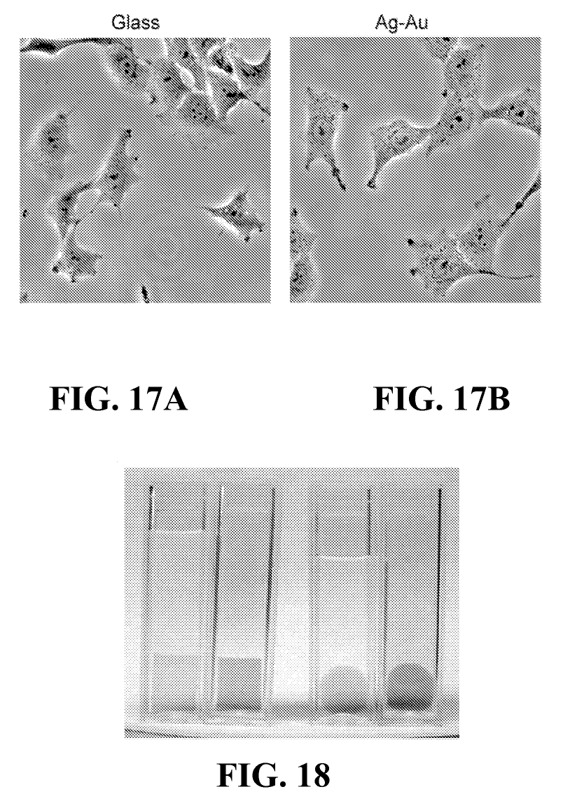

The NP coated substrates of the present invention may be used in a number of applications. For example, the stability of the NP coatings in aqueous environments makes them particularly suitable for use in biologically-oriented applications. As shown in FIG. 16A, AgTMA/AgMUA NP monolayers deposited on glass and PDMS disks exhibit excellent antibacterial properties against both gram-positive (S. Aureus) and gram-negative (E. Coli) bacteria as evidenced by the pronounced zone of inhibition around the coated disks compared to the control disks. Although the inhibition of bacterial growth by colloidal silver is well known and widely used in the art, these commonly-used coatings contain significantly more silver [50, 51] than NP monolayers provided by the present invention (e.g., ˜23 mg Ag/m²). In addition, NP coated substrates of the present invention are not cytotoxic as shown in FIGS. 17A and 17B, can retain antibacterial activity for months and have an easily discernible orange hue, making them attractive as protective films for home-appliance products and medical devices (e.g., on catheters or siloxane implants).

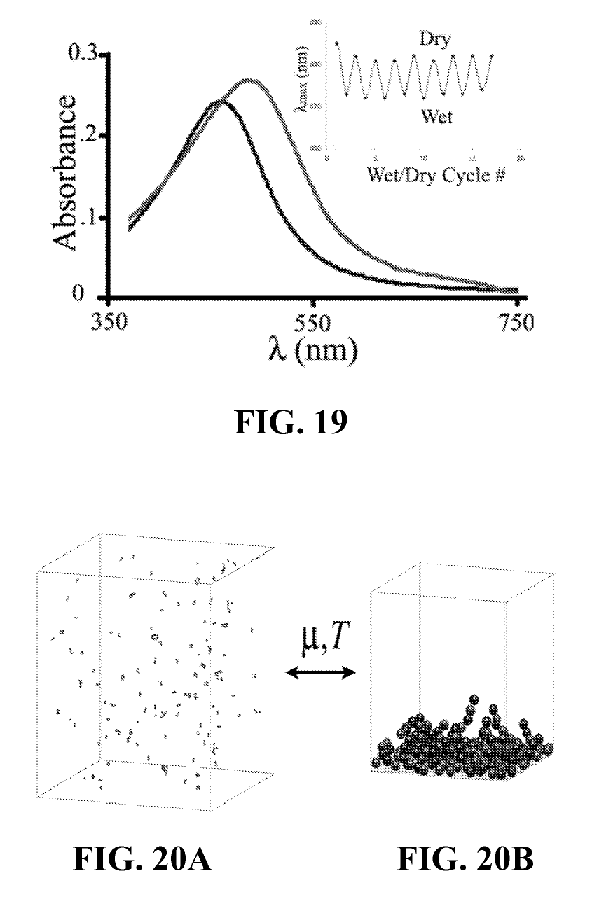

Finally, coatings containing metal particles exhibiting surface plasmon resonance (SPR) may be useful in the context of plasmonic-based detection systems. For example, FIGS. 18 and 19 demonstrate that the NP coatings of the present invention reversibly change color upon immersion in water. In particular, as shown in FIG. 19, the wavelength of maximum adsorption, λₘₐₓ, is shorter in water than in air thus ruling out a possible explanation based on the change of refractive index, n, around the NPs (where it would be expected [52] that λₘₐₓ would increase with n). Instead, a broadening of the SPR band upon drying suggests that the NPs in dry coatings are aggregated but disperse upon hydration, implying that while the NPs are bound to the surface, they retain a certain degree of lateral mobility within the monolayer. This is plausible given that these particles are not covalently bound to the substrate surface.

Without wishing to be bound by any particular theory, theoretical models described in the examples below provide insights into the coating mechanism inherent in the methods disclosed herein. First, a residual charge on the surface may be necessary for NP adsorption.

Second, the fact that only very sparse coatings form from solutions of like-charged particles may be a consequence of electrostatic repulsions between the adsorbed NPs (for TMA NPs) and/or the NPs and the charged surface (for MUA NPs). This conclusion may be supported by a qualitative, thermodynamic argument in which the number of the NPs adsorbed per unit area, n, is estimated by equating the chemical potentials, μ, of the NPs in the solution phase and in a thin (on the order of particle radius, R) layer near the surface:

μₛₒₗ⁰+kT ln ρₛₒₗ=μ_{surf}+kT ln(n/R),

where ρₛₒₗ˜0.3 μM is the number density of NPs in solution (˜1.8·10¹⁴ NPs/mL). Rearranging this expression gives

n=Rρₛₒₗexp(−E_{ad}/kT),

where E_{ad} is the energy of NP adsorption. For example, for a TMA NP coating at equilibrium, the favorable energy between a NP and the oppositely charged substrate is ˜−15 kT at contact, which is partly offset by a repulsive NP-NP energy of ˜7 kT to give E_{ad}˜−8 kT. With these estimates, the expected coating density is only n=0.002 nm⁻² (i.e., ˜10% surface coverage for R=4 nm particles), close to the sparse TMA coatings observed in experiment and in computer simulations. Of course, for MUA NPs, the adsorption energy is strongly unfavorable, and n is negligible.

Third, electrostatic interactions alone are probably unable to induce dense coatings even from mixtures of oppositely charged NPs because the net adsorption energy of oppositely charged NPs is still not sufficiently favorable to form dense coatings (n≈0.02 nm⁻²) in equilibrium with a dilute solution phase (which is also entropically favored). Thus, coating formation likely requires the help of attractive vdW and HB interactions.

Fourth, NP adsorption appears to be a cooperative process requiring participation of NPs of both polarities and is facilitated by vdW and H-bonding interactions.

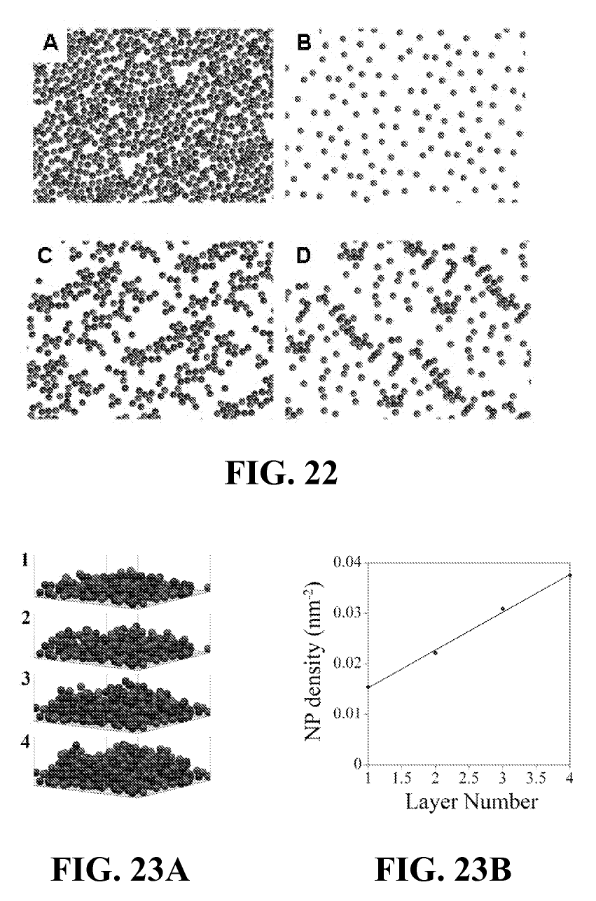

Fifth, the maximal degree of adsorption observed at about pH=7 likely reflects the optimal balance between hydrogen-bonding and electrostatic interactions. At lower pHs, both the substrate and the MUA groups on the NPs are partly protonated, which allows for the formation of more hydrogen bonds but decreases surface charges and favorable electrostatic interactions between MUA and TMA NPs and between the substrate and TMA NPs. Consequently, the coatings that form are relatively sparse. Conversely, at higher pHs, when both MUAs and the ionizable groups on the substrate are deprotonated, H-bond interactions are roughly negligible, also resulting in less dense coatings. These effects are reproduced in the simulations shown in FIGS. 22C and 22D.

Sixth, since the magnitudes of the van der Waals forces are similar for NPs made of different metals (both because the NP-substrate interaction is dominated by the SAM and because the Hamaker constants for different metals are similar), NP adsorption is likely to depend predominantly on the charges and concentrations of the NP and on the properties of the coating ligands rather than the material properties of the metal cores of the NPs.

Finally, the necessity to dry existing coatings before multiple layers of NPs can be deposited may be rationalized by the removal of water and concomitant formation of H-bonds and specific electrostatic interactions (i.e., direct ion-ion pairs) that had previously been “screened” by hydration. As a result of these enhanced interactions, the NPs likely become irreversibly bound to the substrate. When returned to the NP coating solution, the permanently coated surface provides a stable substrate for further absorption of oppositely charged NPs. The computer simulations shown in FIGS. 23A and 23B support this explanation, in which the initial coating was “fixed” to the substrate, and was then equilibrated with the NP solution. These simulations show that the number of NPs per unit area increases linearly with each successive coating, consistent with the experimental observations shown in FIG. 5. Simulations also confirm that when the coatings are not fixed prior to equilibration with the coating solution, no additional deposition occurs.

The formation of NP coatings on substrates according to the methods of the present invention is further illustrated by the following non-limiting examples.

### EXAMPLES

Aspects of the present teachings may be further understood in light of the following examples, which should not be construed as limiting the scope of the present teachings in any way.

Experimental Methods

Unless otherwise specified, the following experimental methods were used in the examples below.

Nanoparticles

Gold (5.8 nm metal core diameter, dispersity σ=11%), silver (5.3, 5.4, and 6.6 nm; σ=15, 40, and 17%, respectively), and palladium (5.3 nm; σ=12.7%) nanoparticles prepared as described previously [21, 22]. Positive charges were introduced onto the NPs [23] by covering them with a self-assembled monolayer (SAM) [24] of N,N,N-trimethyl(11-mercaptoundecyl)-ammonium chloride (TMA, ProChimia Poland). Negatively charged NPs were coated with mercaptoundecanoic acid (MUA, ProChimia).

Nanoparticle Coating Solutions

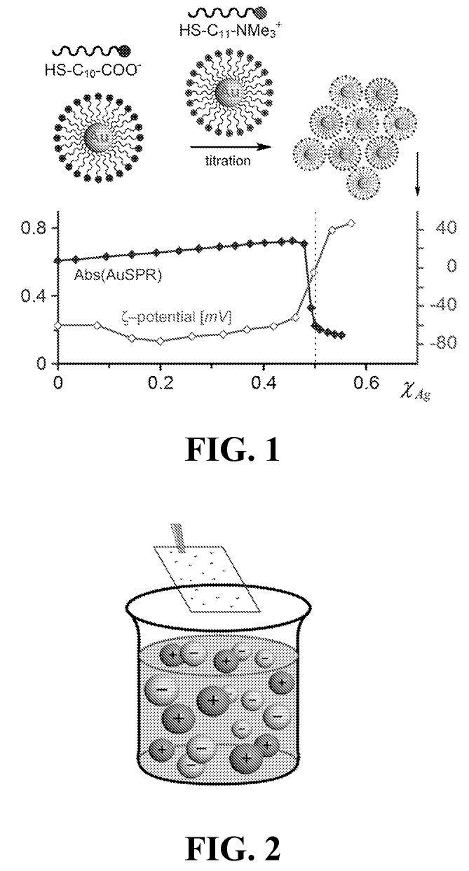

NP coating solutions were prepared by deprotonating MUA NPs at pH=11 [25] and titrating a solution of NPs of either polarity with small aliquots of a solution containing oppositely charged particles. As previously shown [22, 23, 26], the titrated solutions remained stable until precipitating rapidly at the point when the charges of the nanoparticles were neutralized (i.e., when ΣQ_{NP(+)}⁺ΣQ_{NP(-)}=0). FIG. 1 shows the precipitation of oppositely-charged nanoparticles monitored by UV-Vis spectroscopy (blue) and ζ-potential measurements (red). Precipitation is sharp and occurs when the charges on the NPs of opposite polarities are compensated (here, at 1:1 ratio of 5.8 nm AuTMA and 5.8 nm AuMUA nanoparticles) and the overall surface potential goes to zero. The electroneutral nanoparticle precipitate thus obtained (from 0.5-2 mM solutions in terms of atoms of each metal) was washed several times with water to remove salts, redissolved in deionized water at 60-65° C. and finally microfiltered to give a stable (for weeks) 0.5-4 mM solution [23, 26] containing oppositely charged NPs in equal proportions. Immediately prior to use, the pH of the solution was adjusted to a desired value (optimally, pH ˜7; see discussion below) by dropwise addition of HCl or NMe₄OH.

Coating Method

Coated substrates were prepared as follows. First, a desired substrate (e.g., borosilicate glass, poly(dimethyl siloxane), polystyrene, polyethylene, poly(methyl methacrylate) (PMMA), silicon, GaAs, or ITO) was washed with water followed by acetone, and then oxidized in a plasma cleaner (Plasma Prep II, SPI) with air plasma for 15-120 min. As shown schematically in FIG. 2, the substrate was then immersed in the NP coating solution for ˜6 hrs, after which it was washed with deionized water (pH ˜5.5) and dried under nitrogen stream. For all materials investigated, this procedure resulted in a uniform NP coating, which for metal NPs exhibiting surface plasmon resonance (Au, Ag) gave rise to a characteristic hue on transparent substrates. For example, coatings containing Au NPs exhibited a pink-purple hue. SEM images revealed that the coatings had the nanoparticles arranged in a monolayer characterized by ˜60% surface coverage for all hydrophilic substrates as shown in FIG. 3 and FIG. 6. The adsorption process was self-terminating in the sense that the amount of adsorbed NPs did not increase after the first six hours of soaking. On the other hand, additional NPs could be deposited by washing the existing coating with water, drying for ˜20 s under a stream of dry air or nitrogen, and then re-immersing in the coating solution. Each washing-drying-soaking cycle caused the coating's optical absorption to increase by a constant amount corresponding to additional ˜25% of the initially deposited NPs as illustrated in FIG. 5.

### Example 1

### AgTMA-AuMUA Coated Si Substrates

Following the methods above, AgTMA-AuMUA coatings were formed on Si substrates. FIG. 3 shows an SEM image of a AgTMA-AuMUA coating formed on Si. FIG. 4 is an optical picture of: a PPMA cuvette not exposed to the NP coating solution (left); a PPMA cuvette which has been immersed in the NP coating solution for 1 hr but not oxidized prior to immersion (middle); and a PPMA cuvette which has been plasma-oxidized and then immersed in the NP coating solution for 1 hr (right). In FIG. 4, the right cuvette has a pink-purple hue, indicating the presence of AuMUA NPs. FIG. 5 shows the absorption of AgTMA-AuMUA coatings (λₘₐₓ=557-561 nm) for a single and multiple immersions in the NP coating solution. With single immersion, the absorbance stabilizes after ca. 6 hrs. When, however, the coatings are sequentially deposited, washed, and dried, their optical density increases linearly with the number of deposition cycles (indicated by markers on the upper line). The images in FIG. 5 show glass slides coated once, three times, and five times.

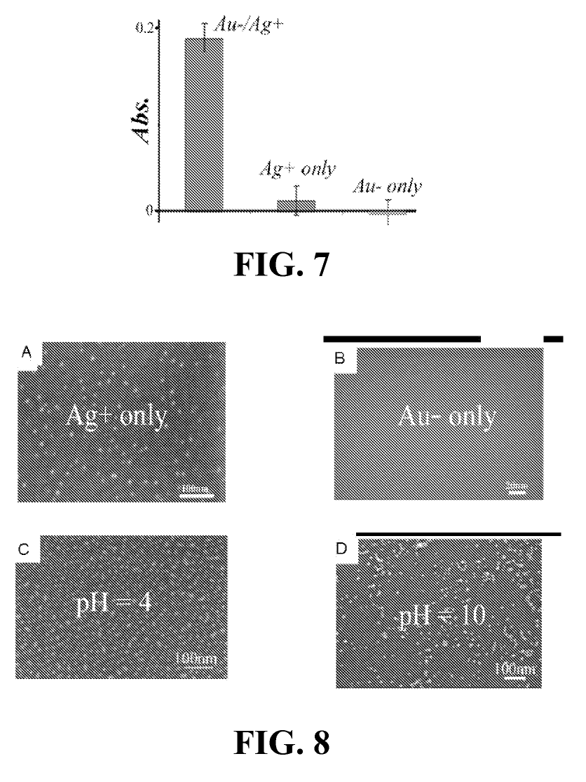

FIG. 6 shows a SEM image of a typical Au/Ag coating formed on oxidized Si from a pH=7 coating solution containing oppositely charged NPs (here, AgTMA and AuMUA). In FIG. 7, the bar on the left (pink) gives the coating's absorbance, Abs≈0.18±0.015, at λₘₐₓ=557-561 nm. The bar in the middle (blue) (Abs≈0.012±0.015) corresponds to a much less dense coating deposited from a coating solution containing only positively charged silver nanoparticles. An image of a coating formed from a coating solution having only positively charged silver nanoparticles is shown in FIG. 8A. As shown in FIG. 8A, residual adsorption (˜3-5% surface coverage) can be observed with NPs coated with positively charged TMA particles. These effects do not appear to depend on the nature of the metal core, but only on the properties of the SAM coating the NPs. When the coating solution contains only negatively charged gold nanoparticles, substantially no deposition is observed (Abs≈−0.002±0.015), as illustrated by the SEM image in FIG. 8B. Finally, when the coating solution is either acidic (FIG. 8C) or basic (FIG. 8D), the resulting coatings are less dense than when the coating solution is at pH=7 (FIG. 6).

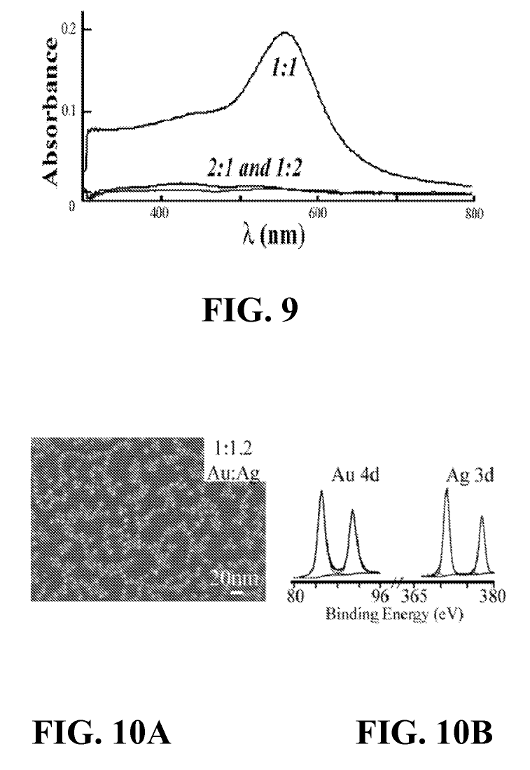

Glass slides were also coated using coating solutions containing different proportions of AuMUA and AgTMA nanoparticles. FIG. 9 provides the UV-Vis spectra of glass slides coated from solutions in which the AuMUA:AgTMA ratio is 1:1, 2:1, and 1:2. The 1:1 ratio yields a much denser coating than either 2:1 or 1:2. FIG. 10 shows the SEM image and the XPS spectrum of a AuMUA/AgTMA coating prepared from solution containing 20% excess of AgTMAs. The XPS spectrum shows that despite unequal NP concentrations in solution, the coating has approximately equal numbers of Au and Ag NPs. FIG. 11 shows the SEM image and the XPS spectrum of a AuMUA/AgTMA coating prepared from a solution containing 60% excess of AuMUAs in solution. The coating is very sparse but is composed of equal proportions of Au and Ag NPs.

### Example 2

### Coatings Composed of NPs Having the Same or Different Metal Cores

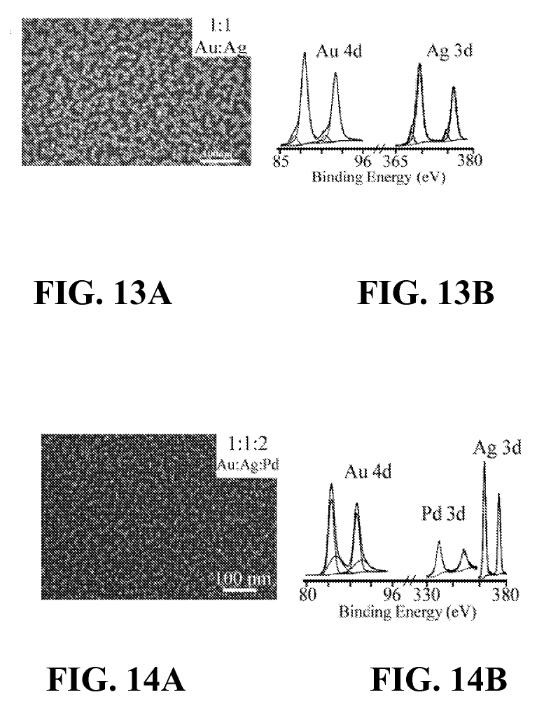

Glass slides were coated using coating solutions comprising NPs having the same metal cores (1:1 ratio of AgTMA and AgMUA), two different cores (1:1 ratio of AuMUA and AgTMA), and three different cores (1:1:2 ratio of AuTMA, AgTMA and PdMUA). The coating solutions for the two-component coatings were prepared according to the above methods. The coating solution for the tri-component coating was prepared by first mixing equal volumes of equimolar AuTMA and AgTMA solutions, and then titrating with a solution of Pd-MUAs until electroneutrality. The re-dissolved precipitate was then used for coating. FIGS. 12-14 show the SEM images and XPS spectra of an AgMUA/AgTMA coating (FIGS. 12A and 12B, respectively), an AuMUA/AgTMA coating (FIGS. 13A and 13B, respectively) and an AuTMA/AgTMA/PdMUA coating (FIGS. 14A and 14B, respectively).

### Example 3

### A Four-Component NP Coating

A four-component (for example, using metals X,Y,Z,W) coating of elemental composition nₓ:n_{y}:n_{z}:n_{w}, is prepared by first mixing like charged X-MUA and Y-MUA NPs in nₓ:n_{y} proportion, titrating them with a n_{z}:n_{w} mixture of Z-TMA and W-TMA NPs until precipitation at the point of electroneutrality, and then coating the desired substrate with the redissolved precipitate.

### Example 4

### NP Coatings On Non-Planar And Microstructured Surfaces

AgTMA-AuMUA coatings were formed on various non-planar and microstructured surfaces. FIG. 15A depicts uncoated (left, clear) and AgTMA-AuMUA coated (right, pink) cylindrical glass vials. FIG. 15B shows the SEM image of an array of 1 μm-wide lines patterned onto the surface of oxidized PDMS that has been coated multiple times with AgTMA/AuMUA NPs. The inset shows a large-area SEM image of the coated substrate. FIG. 15C shows the optical micrograph of a ZnO substrate first microstructured with 10 μm lines using ASoMic [47-49] and then uniformly coated with AgTMA/AuMUA NPs.

### Example 5

### The Antibacterial Activity, Cytotoxicity and Color Properties of NP Coated Substrates

AgTMA/AgMUA NP monolayers were deposited on glass and PDMS disks. As shown in FIGS. 16A and 16B, the coated disks were exposed to both gram-positive (S. Aureus) (FIG. 16B) and gram-negative (E. Coli) (FIG. 16A) bacteria. At 15 hours of growth, pronounced zones of inhibitions around the coated disks exist with an absence of inhibition around uncoated glass controls. The upper of the two blank circles in FIG. 16A corresponds to the experiment in which an NP-coated PDMS disk was initially placed into the culture for 2-3 seconds and then removed. The lack of bacterial growth over this region demonstrates instantaneous, contact-killing properties of the coatings. FIGS. 16A and 16B also reveals the easily discernible orange hue of the coated disks.

FIGS. 17A and 17B show Rat-2 cells on uncoated glass (FIG. 17A) and glass coated with AgTMA/AuMUA (FIG. 17B). The mammalian cells on the coated glass adhere, spread and move with the same morphologies and motility characteristics as on uncoated glass substrates. In addition, the cells on coated substrates remain live and motile (in L15 medium supplemented with 10% serum) for at least several days.

FIG. 18 shows glass pieces coated with AgTMA/AuMUA (the two purple vials on the left) and with AgTMA/AgMUA (the two orange vials on the right). In each pair of vials, the darker vial is dry and the lighter vials is wet. The spectra in FIG. 19 shows significant broadening of the absorption band upon drying (red), which is reversible upon subsequent wetting (blue). The inset shows reversible shifts of the absorption maximum over 9 wetting/drying cycles.

Theoretical Methods

Unless otherwise specified, the following theoretical methods were used in the examples below.

As shown in FIGS. 20A and 20B, the experimental system was modeled as a two-dimensional surface of constant area, A, in equilibrium with a NP solution of fixed chemical potential, μ, and temperature, T. The periodic simulation cell (“reservoir”) had dimensions of 1 μm×1 μm×1 μm in equilibrium (i.e., at constant chemical potential, μ, and temperature, T) with a smaller cell (with typical dimensions of 150 nm×150 nm×150 nm) with the substrate at the z=0 plane. Red spheres denote positively charged TMA NPs and blue spheres are negatively charged MUA NPs.

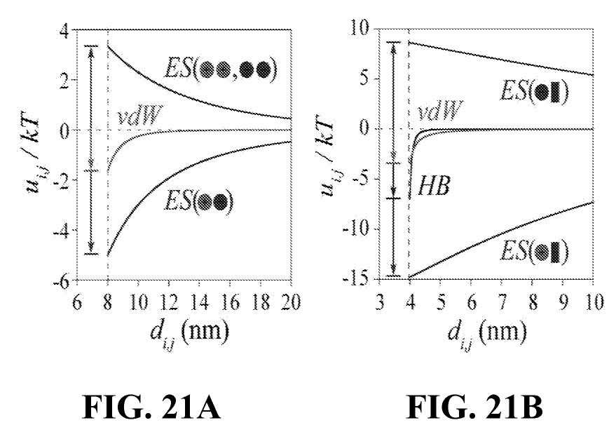

The Grand Canonical Monte Carlo scheme with periodic boundary conditions was used to investigate the influence of electrostatic, van der Waals, and hydrogen-bonding interactions on the coating's density and equilibrium composition. Details of the electrostatic, van der Waals and hydrogen-bonding interactions and the computer simulations are provided below. Shown in FIGS. 21A and 21B are calculated electrostatic (ES), van der Waals (vdW) and hydrogen-bond (HB) potentials at pH=7 for two spheres (FIG. 21A) and for a sphere and surface (FIG. 21B) as a function of their separation. The arrows give the magnitudes of the various types of interactions at contact.

Electrostatic Interactions

Electrostatic interactions between charged NPs in ionic solution and between the NPs and the substrates were derived from the appropriate electrostatic potentials, φ, via thermodynamic integration [27, 28] and accounted for “charge-regulation” at the NPs' surface; i.e., for the equilibrium between counterions adsorbed onto the charged surfaces and those “free” in solution. Briefly, the electrostatic potential around the NPs or the substrate is well approximated by the linearized Poisson-Boltzman (PB) equation,

∇²φ=κ²φ,

where

κ⁻¹=\sqrt{∈₀∈k_{B}T/2ce²}

is the Debye screening length (˜10 nm for our system), c is the monovalent salt concentration, e is the fundamental charge, ∈₀ is permittivity of vacuum, ∈ is the dielectric constant of the solvent, k_{B} is Boltzmann's constant, and T is the temperature. This approximation is reasonable for surface potentials less than ˜60 mV such as those studied here (See below). The adsorption equilibrium at a positively charged surface (here, TMA-coated NPs) presenting N_{T} positively charged groups, A⁺, in a solution containing negatively charged counterions, B⁻, is determined by

N_{A+}C_{B-}/N_{AB}=K₊exp(eφₛ/k_{B}T) [29],

where N_{A+} and N_{AB} are, respectively, the numbers of counterion-free and counterion-bound surface ligands (N_{A+}+N_{AB}=N_{T}), C_{B-} is the concentration of counterions in solution, K₊ is the equilibrium constant in the absence of any external fields, and φₛ is the electrostatic potential at the surface. Measurements were performed on a Brookhaven Instruments Zeta-PALS analyzer for solutions (˜1 mM ionic strength and pH˜10) gave the magnitudes of surface potential 30-60 mV for different types of NPs used (φₛ) was negative for MUA NPs and positive for TMA ones [21, 22]). For the substrates used, the values of surface potentials reported in literature are around −0.05 V. For instance, for plasma oxidized glasses and siloxanes presenting Si—OH groups, φ_{surf}˜−0.03 to −0.09V [30-32]. For polymers, oxidation introduces onto the surface groups such as carboxylic acids and phenols [33], and gives rise to surface zeta-potentials that are ˜−0.09 V for polycarbonate, ˜−0.05V for polystyrene and polyethylene, and ˜−0.03 V for PMMA [34]. For ITO the zeta potential has been measured [35] to be ˜−0.04 V. From this relation, the surface charge density, σ, may be expressed as

σ=eρ/[1+(C_{B-}/K₊)exp(eφₛ/k_{B}T)],

where ρ=N_{T}/4πR² is the surface density of charged groups (e.g., ρ≈2.6 nm⁻² for a TMA SAM [36] on a nanoparticle of the metal core radius R_{c}=3 nm). Assuming the dielectric constant of the TMA SAM (∈ₚ≈2) is small compared to that of the solvent (∈≈80 for water), the surface charge is related to the potential at the NP surface by

σ=−∈₀∈∇φ·\vec{n},

where \vec{n} is the outward surface normal. Equating the two relations for σ provides the necessary boundary condition for a positively charged NP. For the case of negatively charged MUA NPs or for the oxidized substrates, the reasoning is similar, but it is necessary to account for two equilibrium relations, one due to the physical adsorption of counterions and the second due to the protonation/deprotonation of surface groups (e.g., COOH for MUA NPs, Si—OH for oxidized glass or PDMS substrates). Accounting for these equilibria, the charge density of these negatively-charged surfaces is given by

σ=−eρ/[1+(C_{H+}/K_{A}+C_{B+}/K₋)exp(−eφₛ/k_{B}T)],

where C_{H+} is the concentration of H⁺ ions in solution, K_{A} is the acid/base dissociation constant of the ionizable groups (pKₐ≈5 for MUA NPs [25, 37], pKₐ≈7.5 for glass [38]), C_{B+} is the concentration of positively charged counterions in solution, and K₋ is the equilibrium constant for counterion adsorption.

With the experimentally determined values of surface potentials and with other parameters estimated above, the equilibrium constants are estimated as K₋=K₊≈0.06 mM, and solving the PB equation for the case of two interacting NPs [27] and for the case of an NP interacting with a planar substrate yields the interaction potentials shown in FIGS. 21A and 21B. The interesting feature of these dependencies is that the attractive energy between oppositely charged NPs at contact is greater in magnitude than the repulsive energy of like-charged NPs at the same distance. This effect is due to the desorption of counterions from between oppositely charged NPs (where electrostatic potential is low), and adsorption of counterions into the region between like-charged NPs (where potential is high) [39].

Van der Waals (vdW) Interactions

In addition to electrostatic forces, the NPs and the surface interact by attractive vdW interactions, which may be approximated using the Hamaker “hybrid” approximation [40], in which the form of the vdW potential is taken from Hamaker pairwise-summation, with Hamaker constants calculated from the more rigorous Lifshitz theory or taken from experiment. Specifically, for the NP-NP interactions:

$${u}_{i , j}^{vdW} = \frac{A}{3} [ \frac{{R}_{c}^{2}}{( {d}_{i , j}^{2} - 4 {R}_{c}^{2} )} + \frac{{R}_{c}^{2}}{{d}_{i , j}^{2}} + \frac{1}{2} ln ( 1 - \frac{4 {R}_{c}^{2}}{{d}_{i , j}^{2}} ) ] ,$$

Where R_{c}=3 nm is the radius of the metal core, dᵢⱼ is the distance between centers of spheres i and j, and the Hamaker constant A≈4.0×10⁻¹⁹ J for gold across water [41]. For the NP surface interactions,

$${u}_{i , surf}^{vdW} = \frac{{A}_{surf}}{6} [ \frac{R}{( {z}_{i} - R )} + \frac{R}{( {z}_{i} + R )} + ln ( \frac{{z}_{i} - R}{{z}_{i} + R} ) ] ,$$

where R=4 nm is the radius of a SAM-covered NP, z is the distance between the NP center and the plane of the surface, and the Hamaker constant for the NP-surface interaction A_{surf}≈5.3×10⁻²¹ J is similar for all the surfaces studied here. NP-surface Hamaker constants were estimated using an integral approximation of the Lifshitz theory combined with approximate forms for the dielectric permittivity (this approximation is described in [41]). In contrast to the NP-NP interactions, the NP-surface interaction is dominated by the SAM coating, which was allowed to approach the substrate down to a minimum distance of δ=0.2 nm. This value corresponds to a characteristic molecular length scale that has previously been shown to provide good estimates of vdW energies at contact [41] and is approximately equal to the distance of closest approach for hydrogen-bonds (see discussion of hydrogen bonding below).

Hydrogen Bonding

To account for the pH dependence of coating density, hydrogen bonding between the MUA particles (TMA NPs are neither H-bond donors nor acceptors) and between these particles and the polar groups (OH, COOH, phenols and their deprotonated forms [42]) on the surface were considered. These favorable interactions can be related to the number of hydrogen bonds at contact, estimated as

N_{HB}≈A_{eff}ρ(θ_{1A}θ_{2D}+θ_{1D}θ_{2A})

where ρ is the density of H-bonding groups on the surface, θ_{iA} and θ_{iD} are the fraction of such groups on surface i that are, respectively, H-bond accepting and H-bond donating, and A_{eff} is the effective area of contact between the surfaces (A_{eff}≈2πRδ) for two like-sized spheres and A_{eff}≈4πRδ for a sphere in contact with a planar surface [41], where δ=0.2 nm is a characteristic H-bond length). At neutral pH, only the substrate is partially protonated (e.g., ˜16% for glass at pH=7), resulting in N_{HB}≈4.2 possible bonds between each MUA NP and the substrate. With these approximations and using the typical energy of a hydrogen bond ˜10 kJ/mol [41], the energies of NP/NP and NP/surface hydrogen bonding in aqueous solution at pH=7 can be conservatively estimated at, respectively, U≈0 and U_{surf}≈−7 kT (these increase to U≈1 kT and U_{surf}≈−15 kT at pH=4). While these values give only the magnitudes of H-bonding interactions at contact, it is possible to account for their distance dependence using the so-called Boltzmann-averaged “Keesom” potentials [41, 43], which after integration over the interacting domains (sphere-sphere or sphere-plane) give

$${u}_{i , j}^{HB} = \frac{2 U {δ}^{3} R}{{d}_{i , j}} [ \frac{1}{{( {d}_{i , j} + 2 R )}^{3}} - \frac{2}{{d}_{i , j}^{3}} + \frac{1}{{( {d}_{i , j} - 2 R )}^{3}} ]$$

$$and$$

$${u}_{i , surf}^{HB} = {U}_{surf} {δ}^{3} [ \frac{1}{{( {z}_{i} - R )}^{3}} - \frac{1}{{( {z}_{i} - R )}^{3}} ]$$

where d_{i,j}=2R+δ is the distance of closest approach.

Computer Simulations

With all the these individual contributions, the overall energy of the system can be written as

$${U}_{tot} = {\sum }_{i = 1}^{N} {\sum }_{j \geq i}^{N} ( {u}_{i , j}^{ES} + {u}_{i , j}^{vdW} + {u}_{{i}^{*} , {j}^{*}}^{HB} ) + {\sum }_{i = 1}^{N} ( {u}_{i , surf}^{ES} + {u}_{i , surf}^{vdW} + {u}_{{i}^{*} , surf}^{HB} )$$

where N is the total number of NPs in the periodic-boundary simulation cell (typically, 300 as shown in FIG. 7a), and the star (*) denotes that hydrogen bonding interactions are only included for negatively charged (MUA-coated) NPs. The phase space of the adsorbing particles was sampled using the traditional GCMC algorithm [44-46], in which MC moves consisted of particle insertion, displacement, or removal attempts accepted according to the Boltzmann criterion.

### Example 6

### Simulated Monolayer NP Coatings

Computer simulations were used to coat substrates with a single layer of NPs according to the above methods. FIG. 22A shows a dense coating obtained from an equimolar mixture of positive and negative NPs at pH=7. FIG. 22B shows a sparse coating from a solution of positively charged NPs at pH=7. Negatively charged NPs gave no coating on a negatively charged surface. FIG. 22C shows that at pH=4, hydrogen bonding increases, but the net charges of the negatively charged surfaces (i.e., MUA covered NPs and the substrate) decrease. As a result, the coating is sparser than at pH=7. FIG. 22D shows that at pH=10, the magnitude of the hydrogen bonding interactions decreases and also leads to low surface coverages.

### Example 7

### Simulated Multilayer NP Coatings

Computer simulations were also used to coat substrates with multiple layers of NPs. As shown in the left side of FIG. 23A, in layer 1, the bare substrate is first equilibrated with the NP coating solution, and all NPs within 1.25 particle diameters from the surface are then fixed in place approximating the experimental process of drying. However, allowing for limited “lateral” mobility of the NPs in the plane of the monolayer led to qualitatively similar results. Fixed NPs act as a new, modified substrate onto which the next layer is absorbed. The procedure is repeated sequentially to yield coatings of increasing thickness. The graph of FIG. 28B shows that the number of NPs deposited per unit area increases linearly with the number of deposition cycles.

### Example 8

### Antimicrobial Monolayers of Silver Nanoparticles

Silver coatings are well known to confer bacteriostatic and bactericidal properties to surfaces. Although the mechanism of inhibitory action of silver on microorganisms is not fully understood, it is generally believed that it is mediated by the Ag⁺ ions which interact with sulfhydryl groups of proteins [53] causing their denaturation [54, 55] and with the bacterial DNA impeding its replication. Silver coatings are currently used in a variety of medical and consumer products including catheters [56], surgical masks [57], suture threads [58], wound creams and dressings [59], cell phones (Motorola), refrigerators (Whirlpool, Samsung), and recently FDA approved food packaging [60, 61]. Traditional methods for the preparation of such coatings are often material-specific [62], require numerous coat-rinse steps [63], or are incompatible with corrugated/microstructured surfaces, e.g. for lab-on-a-chip and other microfluidic applications.

While various sputtering/evaporation methods can be effective in coating open, flat surfaces with minimal amounts of silver, they rely on a direct line-of-sight access to the substrate—consequently, these methods give uneven silver coverage on inclined surfaces and cannot be extended to surfaces with overhangs or closed spaces. In this context, silver nanoparticles present an attractive alternative since they can be deposited from solution onto arbitrarily shaped substrates and can give very thin coatings with total silver content below the safe reference dose (estimated at 5 μg/kg/day [64]—that is, 25 μg/day for a 5 kg infant and 350 μg/day for a 70 kg adult). However, although the synthesis and functionalization of the AgNPs [65, 66] themselves is straightforward, the general schemes of their direct immobilization onto various types of materials are still lacking. Most work to date has relied on layer-by-layer deposition [67], occlusion of the NPs in a polymer [68], gel [19], or zeolite [69] matrices, or on substrate specific chemical interactions (e.g. carbamate-silver interactions in AgNP coated polyurethane foams [70]).

It has been recently shown [66] that electrostatic forces provide a versatile and efficient route to high-quality nanoparticle coatings. Specifically, it has been demonstrated that mixtures of metal NPs functionalized with oppositely charged alkane thiols adsorb cooperatively (FIGS. 26A and 26B) onto a variety of plasma oxidized materials (e.g., glasses, polymers, elastomers and semiconductors) to form dense and stable NP monolayers.

Here, the phenomenon of cooperative adsorption is used to prepare silver nanoparticle coatings on poly(dimethyl siloxane) (PDMS), polyester (PES), Polyethylene Terephthalate Glycol (PETG)/polyethylene terephthalate copolymer (PET) and polystyrene (PS). The coated surfaces have excellent antibacterial potency against both Gram-positive (S. aureus) and Gram-negative (E. coli) bacteria. The prolonged antibacterial activity of AgNP coatings which results the slow release of Ag⁺ from the nanoparticles is also demonstrated and the rate of release is quantified using a novel dithiol-based precipitation method coupled with ICP-MS analysis.

Experimental

Coating Suspension

Coatings were deposited from a suspension containing ˜5 nm, oppositely charged silver (or silver and gold) nanoparticles stabilized with self-assembled monolayers (SAMs) [66] of ω-functionalized alkane thiols. The positively charged particles were coated with N,N,N-trimethyl(11-mercaptoundecyl)-ammonium chloride (TMA, ProChimia Poland); negatively charged NPs were coated with mercaptoundecanoic acid (MUA, ProChimia) [26]. The coating NP solutions were prepared by deprotonating MUA NPs at pH=11 and titrating a solution of NPs of either polarity with small aliquots of a solution containing oppositely charged particles. As has been demonstrated previously [66, 23, 26], the titrated solutions remained stable until precipitating rapidly at the point when the charges of the nanoparticles were neutralized (i.e., when ΣQ_{NP(+)}+ΣQ_{NP(-)}=0). The electroneutral nanoparticle precipitate thus obtained (from 0.5-2 mM solutions in terms of atoms of each metal) was washed several times with water to remove salts, redissolved in deionized water at 60-65° C. and then microfiltered to give a stable (for weeks) 0.5-2 mM solution containing oppositely charged NPs in equal proportions. Immediately prior to use, the pH of the solution was adjusted to a desired value (optimally, pH˜7; [66]) by dropwise addition of HCl or NMe₄OH.

Substrates

The materials tested in this study included glass (i.e., 10 mm cover slips from R. A. Lamb), poly(dimethyl siloxane) (Dow, Sylgaard 184), Polyester (PES), PETG/Polyethylene terephthalate copolymer (PET) and Polystyrene (PS), all purchased from Tom Thumb (Chicago, Ill.). For polymeric materials, circular, ˜10 mm disks were cut manually from the polymer sheets, rinsed with copious amounts of water and ethanol, and dried under nitrogen stream. Immediately prior to NP deposition, the disks were exposed to oxygen plasma (SPI, Plasma Prep II) for 10 min.

Coating Deposition

Oxidized disks were immersed in the coating solution for ˜1 hr (though shorter times, 10 min also produced dense coatings). Subsequently, the disks were rinsed for 20-30 sec. in a large beaker of deionized water, and were dried in a stream of dry air. The morphology of the coatings was analyzed by SEM.

Growth of Bacterial Cultures and Coating Testing

Mueller-Hinton Agar plates (Hardy Diagnostics), E. coli (ATCC 25922) and S. aureus (ATCC 25923) (PML Microbiologics), as well as bacterial growth media LB-Miller and Trypticase Soy broth were obtained through VWR. Bacteria were streaked on LB-agar plates and grown at 37° C. for 16 hrs when colonies were isolated. Sterile batches of LB-broth were inoculated with the colonies, and grown overnight (16 hrs). Bacterial concentrations were quantitated using a Neubauer cytometer and had density of 2.08×10⁹ cfu/mL for E. coli and 1.98×10⁹ for S. Aureus. The Kirby-Bauer disk diffusion test [66] was used to test coatings for antibacterial activity. After Mueller-Hinton (MH) agar plates were inoculated with bacteria and left to stay for ˜2-3 min to dry, uncoated (control) and NP-coated disks were placed onto the gel. The plates were turned upside down and incubated at 37° C. for 16 hrs.

Measuring the Release of Ag⁺ from Ag NP Solution

6 mL of 113 mM freshly prepared AgMUA (or AgTMA) NP solution was allowed to age for up to one month. During this time, small (500 μL) aliquots were taken from the solution, diluted to 5 mL with acetone and precipitated by addition of 1 mL of 97% 1,6-Hexanedithiol (VWR). The nanoparticle-free supernatant was then analyzed for the content of Ag⁺ ions using Inductively Coupled Plasma (ICP) measurements.

Results and Discussion

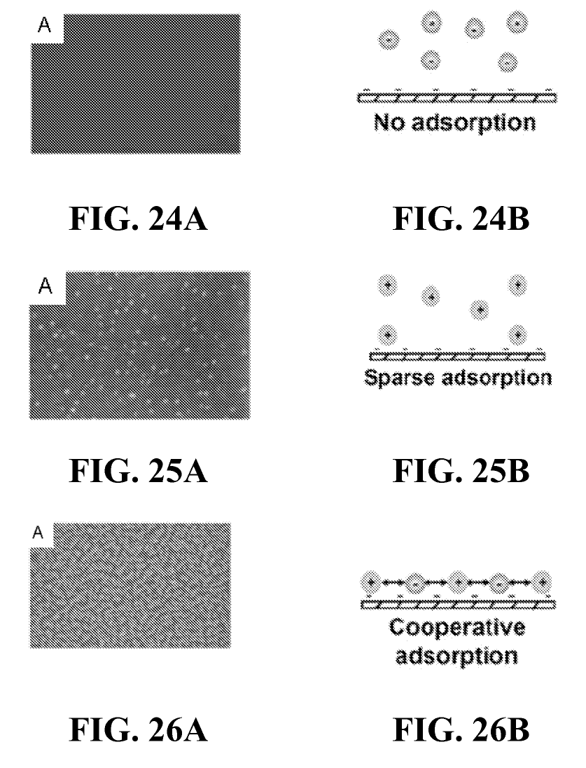

Irrespective of the substrate, all deposited coatings were NP monolayers with surface coverages ˜65%. The mechanism of the coating formation has been described in detail [66]. Basically, the coatings form as a result of electrostatic interactions between the charged nanoparticles and between the nanoparticles and the oxidized substrate whose surface bears residual negative charge developed during plasma oxidation (FIGS. 26A and 26B). Importantly, coatings do not form from pure MUA NPs because of repulsions between particles and the substrate as shown in FIGS. 24A and 24B. Also, only sparse coatings form from pure TMA NPs because of repulsions between adsorbed particles as shown in FIGS. 25A and 25B. In contrast, coatings are deposited from mixtures of oppositely charged NPs as shown in FIGS. 26A and 26B. With such mixtures, the energetically unfavorable adsorption of negatively charged MUA AgNPs onto the negatively charged substrate is compensated by the favorable +/− interactions in the adsorbed “patchy” coatings and also by the screening of electrostatic repulsions between like-charged particles by the NPs metal cores (so that electrostatic forces are short-ranged).

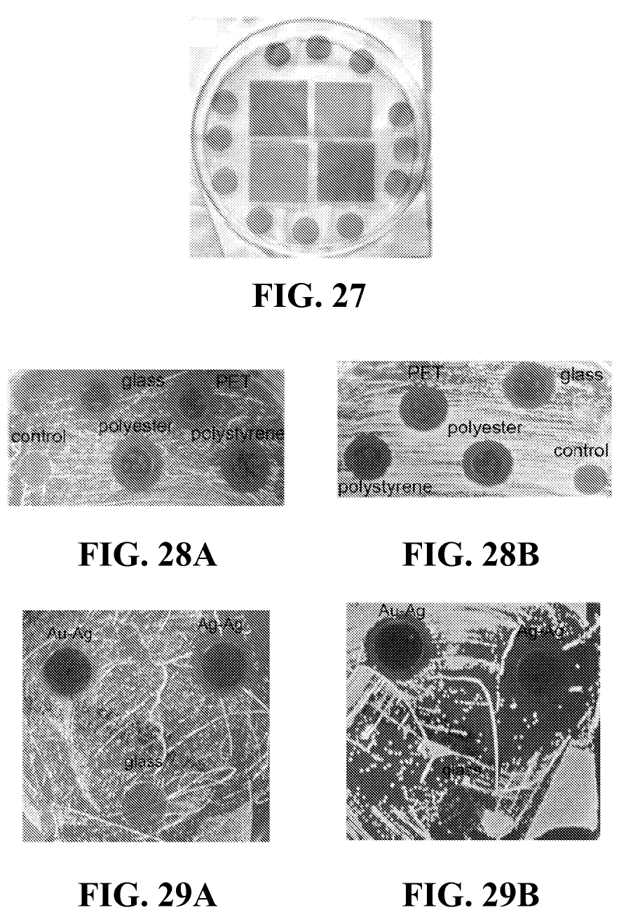

Optically, the coatings have characteristic hues as shown in FIG. 27 resulting from the surface on plasmon resonance (SPR) of the constituent nanoparticles. For example, all-silver AgMUA/AgTMA coatings have a maximum of adsorption at λₘₐₓ˜424 nm and appear orange whereas coatings incorporating gold particles (e.g., AuMUA/AgTMA) have additional adsorption maximum at λₘₐₓ˜520 nm and appear dark pink. As shown in FIG. 27, these colors are vivid owing to the extremely high extinction coefficients of the NPs (e.g., ∈˜6,000 M⁻¹cm⁻¹).

Despite very low content of silver, ˜2.3 μg/cm², the coatings deposited on all tested substrates have excellent antibacterial properties provided that they are “aged” for at least three days (i.e., coatings made of fresh NPs not effective). FIGS. 28A and 28B show the pronounced zones of inhibition (ZOIs) (i.e., regions over which the bacterial growth is absent) around glass and PDMS disks coated with AgMUA/AgTMA monolayers. For comparison, the uncoated disks made of the same materials have no zones of inhibition around them. Pronounced ZoI's are also observed for AgNP-coated polyester, PET and polystyrene disks (FIGS. 28A and 28B) indicating that antibacterial activity is not specific to a particular polymeric support.

At the same time, antibacterial properties derive specifically from the silver particles, and any admixtures of other types of NPs decrease the zones of inhibition, as illustrated in FIGS. 29A and 29B comparing all-silver (AgMUA/AgTMA) coatings with silver-gold (AuMUA/AgTMA) ones.

Lastly, for all supporting materials and NPs used, the coatings retain antibacterial activity for weeks to months. SEM imaging indicates that during this time the constituent NPs are structurally stable also when soaked in DI water and also salt solutions (e.g., KCl) up to 1 M.

As mentioned above, bacteriostatic effects of silver are commonly attributed to Ag⁺ cations. At the same time, the AgNPs in the coatings described herein are composed of metallic silver (i.e., Ag⁰). To reconcile these two observations, a mechanism has been proposed by which silver atoms comprising the NPs are oxidized and released from these nanoparticles. Although AgNPs we use are coated with self-assembled monolayers of tightly-binding (ΔG_{adsorption}˜−5.5 kcal/mol [71] alkane thiols, it is known that these monolayers are permeable to oxygen [72] which can oxidize metallic silver to Ag⁺ (2RSH+½O₂→RSSR+H₂O [72]). If this is so, the concentration of Ag⁺ present in solution containing AgNPs should increase with time. Furthermore, since the structure of the NPs comprising the coatings does not change perceptibly over the course of days to weeks (as verified by SEM measurements above), this release is expected to be slow and the amounts of released silver low.

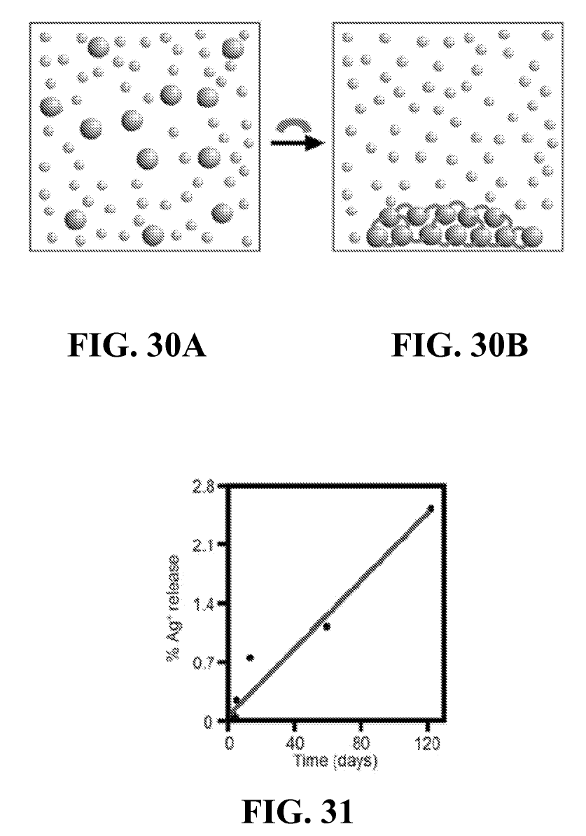

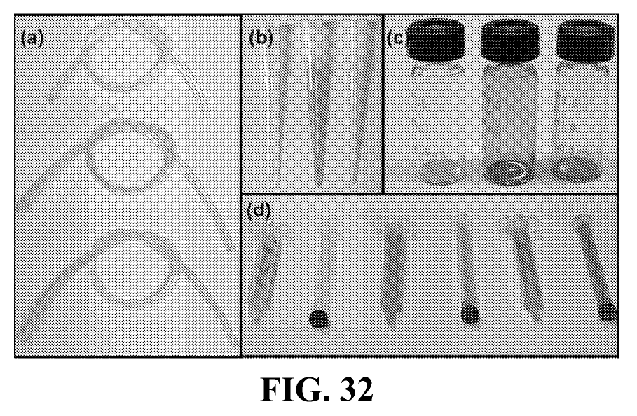

These hypotheses were verified by Inductively Coupled Plasma Mass Spectrometry (ICP-MS), which is a highly sensitive method of metal detection. In the experiments, ˜100 mM AgNP solutions were used rather than monolayer coatings, since the release from the latter was below the detection limit of the ICP-MS spectrometer used (˜0.1 ppm). To make detection specific to free Ag⁺ cations (and not Ag⁰ in the NPs), we developed a selective precipitation procedure in which a large excess (˜10⁷ molecules per one NP) of alkane dithiols, HS—(CH₂)₆—SH was added to the solution prior to ICP-MS analysis. As we have shown earlier [71, 72], dithiols crosslink the silver NPs, causing them to aggregate and precipitate. Importantly, in doing so, they do not precipitate Ag⁺ cations, which remain is solution and can be analyzed by ICP-MS (FIGS. 30A and 30B).

FIG. 31 is a graph showing the dependence of Ag⁺ release as a function of time. The fraction of silver atoms that are oxidized and released from the NPs, χ=[Ag⁺]/([Ag⁰]+[Ag⁺]), increases with time approximately linearly and reaches ˜2.5% after t=120 days.

The observed rate of release can account for the dimensions of the zones of inhibition formed around NP-coated disks. The following formula relates the thickness of the inhibition zone, H_{ZoI}, around a circular source of an antibacterial agent to this agent's concentration, c, and diffusion coefficient, D (˜10⁻⁵ cm²/sec For Ag⁺ in wet hydrogels):

H_{ZoI}=\sqrt{ln(c/c*)Dt} [73, 74, 75].

In this expression, c* is the minimum amount of the agent (here, Ag⁺) required to stop bacterial growth completely. In independent experiments using AgCl salt, this concentration was determined to be c*˜2.5×10⁻⁵ μmol/mL, which is close to the value reported by others [76]. Using this value and estimating the concentrations of Ag⁺ ions released from the coated disks into 1-mm-thick agar gel layer from FIG. 31 gives the thicknesses of ZoI commensurate to those observed experimentally. For instance, for t=16 hrs, the estimated concentration [Ag⁺] ˜2.6×10⁻⁵ μmole/mL yields H_{ZOI}˜0.15 cm, close to the H_{ZOI} observed experimentally for both E. coli (i.e., 0.141 cm) and S. aureus (i.e., 0.245 cm).

### CONCLUSIONS

Cooperative electrostatic adsorption of oppositely-charged AgNPs provides an efficient route to antibacterial coatings. The major advantages of this method are the ease of deposition from aqueous solutions, applicability to a variety of substrates and the durability of the coatings. The slow rate of release of Ag⁺ cations from the thiol-protected nanoparticles, renders these coatings effective over relatively long periods of time (at least weeks) relevant to many practical applications (e.g., food packaging). In addition, the characteristic hue of the coatings provides easily discernible indication of their presence and structural integrity. Ag NPs coated with different types of SAMs can be used to regulate the speed of Ag⁺ release (e.g., shorter thiols should permit higher rate of silver oxidation) and to particles of different metal cores (e.g., antifungal copper NPs [68]).

While the foregoing specification teaches the principles of the present invention, with examples provided for the purpose of illustration, it will be appreciated by one skilled in the art from reading this disclosure that various changes in form and detail can be made without departing from the true scope of the invention.

### REFERENCES

[1] Coe-Sullivan, S.; Steckel, J. S.; Woo, W. K.; Bawendi, M. G.; Bulovic, V. Adv. Funct. Mater. 2005, 15, 1117-1124.
[2] Dabbousi, B. O.; Murray, C. B.; Rubner, M. F.; Bawendi, M. G. Chem. Mat. 1994, 6, 216-219.
[3] Kiely, C. J.; Fink, J.; Brust, M.; Bethell, D.; Schiffrin, D. J. Nature 1998, 396, 444-446.
[4] Kiely, C. J.; Fink, J.; Zheng, J. G.; Brust, M.; Bethell, D.; Schiffrin, D. J. Adv. Mater. 2000, 12, 640-643.
[5] Dong, T. Y.; Wu, H. H.; Lin, M. C. Langmuir 2006, 22, 6754-6756.
[6] Ahn, J. S.; Hammond, P. T.; Rubner, M. F.; Lee, I. Colloid Surf A-Physicochem. Eng. Asp. 2005, 259, 45-53.
[7] Shen, G. X.; Chen, Y. C.; Lin, C. J. Thin Solid Films 2005, 489, 130-136.
[8] Kim, T. J.; Son, D.; Cho, J.; Park, B.; Yang, H. Electrochim. Acta 2004, 49, 4405-4410.
[9] Lee, S. W.; Drwiega, J.; Wu, C. Y.; Mazyck, D.; Sigmund, W. M. Chem. Mat. 2004, 16, 1160-1164.
[10] Prevo, B. G.; Hwang, Y.; Velev, O. D. Chem. Mat. 2005, 17, 3642-3651.
[11] Currie, E. P. K.; Tilley, M. J. Soc. Inf. Disp. 2005, 13, 773-780.
[12] Kommireddy, D. S.; Sriram, S. M.; Lvov, Y. M.; Mills, D. K. Biomaterials 2006, 27, 4296-4303.
[13] Musick, M. D.; Keating, C. D.; Lyon, L. A.; Botsko, S. L.; Pena, D. J.; Holliway, W. D.; McEvoy, T. M.; Richardson, J. N.; Natan, M. J. Chem. Mat. 2000, 12, 2869-2881.
[14] Chen, S. W. Langmuir 2001, 17, 2878-2884.
[15] Niemeyer, C. M.; Ceyhan, B.; Noyong, M.; Simon, U. Biochem. Biophys. Res. Commun. 2003, 311, 995-999.
[16] Zhao, L. Y.; Eldridge, K. R.; Sukhija, K.; Jalili, H.; Heinig, N. F.; Leung, K. T. Appl. Phys. Lett. 2006, 88.
[17] Quinn, B. M.; Dekker, C.; Lemay, S. G. J. Am. Chem. Soc. 2005, 127, 6146-6147.
[18] Paul, S.; Pearson, C.; Molloy, A.; Cousins, M. A.; Green, M.; Kolliopoulou, S.; Dimitrakis, P.; Normand, P.; Tsoukalas, D.; Petty, M. C. Nano Lett. 2003, 3, 533-536.
[19] Fan, H. Y.; Wright, A.; Gabaldon, J.; Rodriguez, A.; Brinker, C. J.; Jiang, Y. B. Adv. Funct. Mater. 2006, 16, 891-895.
[20] Lee, D.; Rubner, M. F.; Cohen, R. E. Nano Lett. 2006, 6, 2305-2312.
[21] Kalsin, A. M.; Grzybowski, B. A. Nano Lett. 2007, 7, 1018-1021.
[22] Kalsin, A. M.; Kowalczyk, B.; Wesson, P.; Paszewski, M.; Grzybowski, B. A. J. Am. Chem. Soc. 2007, 129, 6664-6665.
[23] Kalsin, A. M.; Fialkowski, M.; Paszewski, M.; Smoukov, S. K.; Bishop, K. J. M.; Grzybowski, B. A. Science 2006, 312, 420-424.
[24] Witt, D.; Klajn, R.; Barski, P.; Grzybowski, B. A. Curr. Org. Chem. 2004, 8, 1763-1797.
[25] Leopold, M. C.; Black, J. A.; Bowden, E. F. Langmuir 2002, 18, 978-980.
[26] Kalsin, A. M.; Pinchuk, A. O.; Smoukov, S. K.; Paszewski, M.; Schatz, G. C.; Grzybowski, B. A. Nano Lett. 2006, 6, 1896-1903.
[27] Carnie, S. L.; Chan, D. Y. C.; Gunning, J. S. Langmuir 1994, 10, 2993-3009.
[28] Verwey, E. J. W.; Overbeek, J. T. G., Theory of the Stability of Lyophobic Colloids. Elsevier: N.Y., 1948.
[29] Carnie, S. L.; Chan, D. Y. C. J. Colloid Interface Sci. 1993, 161, 260-264.
[30] Gu, Y. G.; Li, D. Q. J. Colloid Interface Sci. 2000, 226, 328-339.
[31] Kirby, B. J.; Hasselbrink, E. F. Electrophoresis 2004, 25, 187-202.
[32] Lee, G. B.; Lin, C. H.; Lee, K. H.; Lin, Y. F. Electrophoresis 2005, 26, 4616-4624.
[33] Wiles, J. A.; Fialkowski, M.; Radowski, M. R.; Whitesides, G. M.; Grzybowski, B. A. J. Phys. Chem. B 2004, 108, 20296-20302.
[34] Kirby, B. J.; Hasselbrink, E. F. Electrophoresis 2004, 25, 203-213.
[35] Tseng, W. J.; Tzeng, F. Colloid Surf. A-Physicochem. Eng. Asp. 2006, 276, 34-39.=
[36] Sellers, H.; Ulman, A.; Shnidman, Y.; Eilers, J. E. J. Am. Chem. Soc. 1993, 115, 9389-9401.
[37] Lide, D. R., CRC handbook of chemistry and physics on CD-ROM. 87th ed.; CRC Press: Boca Raton, Fla., 2007.
[38] Hiemstra, T.; Dewit, J. C. M.; Vanriemsdijk, W. H. J. Colloid Interface Sci. 1989, 133, 105-117.
[39] Bishop, K. J. M.; Grzybowski, B. A. Phys. Chem. Chem. Phys. 2007, submitted.
[40] Parsegian, V. A., Van der Waals forces: a handbook for biologists, chemists, engineers, and physicists. Cambridge University Press: New York, 2006.
[41] Israelachvili, Intermolecular and Surface Forces. 2nd ed.; Academic Press: New York, 1991.
[42] Joesten, M. D.; Schaad, L. J., Hydrogen Bonding. Marcel Dekker, Inc.: New York, 1974.
[43] Klajn, R.; Bishop, K. J. M.; Grzybowski, B. A. Proc. Nat. Acad. Sci. USA 2007, 104, 10305-10309.
[44] Allen, M. P.; Tildesley, D. J., Computer Simulations of Liquids. Clarendon Press: Oxford, 1987.
[45] Frenkel, D.; Smit, B., Understanding Molecular Simulation. 2nd ed.; Academic Press: New York, 2002.
[46] Norman, G. E.; Filinov, V. S. High Temp. (USSR) 1969, 7, 216-222.
[47] Smoukov, S. K.; Bishop, K. J. M.; Klajn, R.; Campbell, C. J.; Grzybowski, B. A. Adv. Mater. 2005, 17, 1361-1365.
[48] Campbell, C. J.; Smoukov, S. K.; Bishop, K. J. M.; Baker, E.; Grzybowski, B. A. Adv. Mater. 2006, 18, 2004-2008.
[49] Smoukov, S. K.; Grzybowski, B. A. Chem. Mater. 2006, 18, 4722-4723.
[50] Song, J. S.; Lee, S.; Cha, G. C.; Jung, S. H.; Choi, S. Y.; Kim, K. H.; Mun, M. S. J. Appl. Polym. Sci. 2005, 96, 1095-1101.
[51] Zaporojtchenko, V.; Podschun, R.; Schurmann, U.; Kulkarni, A.; Faupel, F. Nanotechnology 2006, 17, 4904-4908.
[52] Tanahashi, I.; Yamazaki, F.; Hamada, K. Chem. Lett. 2006, 35, 454-455.
[53] Son W K, Youk J H, Lee T S, Park W H., Preparation of Antimicrobial Ultrafine Cellulose Acetate Fibers with Silver Nanoparticles, Macromolecular Rapid Communications 2004; 25: 1632-1637.
[54] Feng Q L, Wu J, Chen G Q, Cui F Z, Kim T N, Kim J O. A mechanistic study of the antibacterial effect of silver ions on Escherichia coli and Staphylococcus aureus. J. Biomed. Mater. Res. 2000; 52: 662-668.
[55] Spadaro J A, Berger T J, Barranco S E, Becker R O. Antibacterial effects of silver electrodes with weak direct current. Antimicrobial agents and chemotherapy 1974; 6: 637-642.
[56] Pai M P, Pendland S L, Danziger L H. Antimicrobial-coated/bonded and -impregnated intravascular catheters. Ann. Pharmacother. 2001; 35: 1255-1263.
[57] Li Y, Leung P, Yao L, Song Q W, Newton E. Antimicrobial effect of surgical masks coated with. nanoparticles. J. Hosp. Infect. 2006; 62: 58-63.
[58] Blaker J J, Nazhat S N, Boccaccini A R. Development and characterisation of silver-doped bioactive glass-coated sutures for tissue engineering and wound healing applications. Biomaterials 2004; 25: 1319-1329.
[59] Tredget E E, Shankowsky H A, Groeneveld A, Burrell R A. Matched-Pair, Randomized Study Evaluating the Efficacy and Safety of Acticoat Silver-Coated Dressing for the Treatment of Burn Wounds. J. Burn Care Rehabil. 1998; 19: 531-537.
[60] Del Nobile M A, Cannarsi M, Altieri C, Sinigaglia M, Favia P, Iacoviello G, et al. Effect of Ag-containing Nano-composite Active Packaging System on Survival of Alicyclobacillus acidoterrestris. J. Food Sci. 2004; 69: E379-383.
[61] Quintavalla S, Vicini L. Antimicrobial food packaging in meat industry. Meat Sci. 2002; 62: 373-380.
[62] Xia Y N, Zhao X M, Whitesides G M. Pattern transfer: self-assembled monolayers as ultrathin resists. Microelectron. Eng. 1996; 32: 255-268.
[63] Hammond P T. Form and Function in Multilayer Assembly: New Applications at the Nanoscale. Adv. Mater. 2004; 16: 1271-1293.
[64] Fung, M. C.; Bowen, D. L. Silver products for medical indications: risk-benefit assessment. J. Toxicol.-Clin. Toxicol. 1996; 34: 119-126.
[65] Nikhil R J, Peng X. Single phase and gram scale routes toward nearly monodisperse Au and other noble metal nanoparticles. J. Am. Chem. Soc. 2003; 125: 14280-14281.
[66] Smoukov S K, Bishop K J M, Kowalczyk B, Kalsin A M, Grzybowski B A. Electrostatically “Patchy” coatings via cooperative adsorption of charged nanoparticles. J. Am. Chem. Soc. 2007; 129: 15623-15630.
[67] Clement J L, Jarrett P S. Antibacterial silver. Met.-Based Drugs 1994; 1: 467-482.
[68] Cioffi N, Torsi L, Ditaranto N, Tantillo G, Ghibelli L, Sabbatini L et. al. Copper Nanoparticle/Polymer Composites with Antifungal and Bacteriostatic Properties. Chem. Mater. 2005; 17: 5255-5262.
[69] Matsumura Y, Yoshikata K, Kunisaki S, Tsuchido T. Mode of Bactericidal Action of Silver Zeolite and Its Comparison with That of Silver Nitrate. Appl. Environ. Microbiol. 2003; 69: 4278-81.
[70] Prashant J, Pradeep T. Potential of silver nanoparticle-coated polyurethane foam as an antibacterial water filter. Biotech. Bioeng. 2005; 90: 59-63.
[71] Karpoich D S and Blanchard G J. Direct Measurement of the Adsorption Kinetics of Alkanethiolate Self-Assembled Monolayers on a Microcrystalline Gold Surface. Langmuir 1994; 10: 3315-3322.
[72] Bagiyan G A, Koroleva I K, Soroka N V, Ufimtsev. Oxidation of thiol compounds by molecular oxygen in aqueous solutions. Russ. Chem. Bull. Int. Ed. 2003; 52: 1135-1141.
[73] Kavanagh, F. Analytical Microbiology. Academic Press Inc. 1963, p 1-86.
[74] Lee D, Cohen R E, Rubner M F. Antibacterial Properties of Ag Nanoparticle Loaded Multilayers and Formation of Magnetically Directed Antibacterial Microparticles. Langmuir 2002; 21: 9651-9659.
[75] Cooper, K E Theory of Inhibition Zone in Agar media. Nature 1955; 176: 510-511.
[76] Morones J R, Elechiguerra J L, Camacho A, Holt K, Kouri J B, Ramirez J T et. al. The bactericidal effect of silver nanoparticles. Nantotechnology 2005; 16: 2346-2353.
[77] Bensemann I T, Fialkowski M, Grzybowski B A. Wet Stamping of Microscale Periodic Precipitation Patterns. J. Phys. Chem. B 2005; 109: 2774-2778.

What is claimed is:

1. A method comprising:
contacting a surface of a substrate with an aqueous solution comprising first nanoparticles having positively charged moieties on a surface thereof and second nanoparticles having negatively charged moieties on a surface thereof; and
adsorbing the first and second nanoparticles onto the surface to form an adsorbed nanoparticle coating on the surface of the substrate.

2. The method of claim 1, wherein the first nanoparticles and the second nanoparticles comprise a metal.

3. The method of claim 1, wherein the first metal nanoparticles and the second metal nanoparticles comprise the same or different metals.

4. The method of claim 1, wherein the first nanoparticles and the second nanoparticles each independently comprise a metal selected from the group consisting of Au, Ag, Pt, Cu and Pd.

5. The method of claim 1, wherein the positively charged moieties comprise a moiety selected from the group consisting of: a positively charged alkyl-thiol moiety; a positively charged aryl-thiol moiety; a positively charged C₆-C₁₆ n-alkyl thiol moiety; and N,N,N-trimethyl(11-mercapto-undecyl)-ammonium chloride.

6. The method of claim 1, wherein the negatively charged moieties comprise a moiety selected from the group consisting of: a negatively charged alkyl-thiol moiety; a negatively charged aryl-thiol moiety; a negatively charged C₆-C₁₆ n-alkyl thiol moiety; and mercapto undecanoic acid.

7. The method of claim 1, wherein the substrate comprises a material selected from the group consisting of a glass, a polymer, silicon, GaAs and tin doped Indium Oxide (ITO).

8. The method of claim 1, wherein the substrate comprises a material selected from the group consisting of borosilicate glass, poly(dimethyl siloxane), polystyrene, polyethylene, and poly(methyl methacrylate).

9. The method of claim 1, further comprising oxidizing the surface to form an oxide on the surface prior to contacting the surface with the aqueous solution, wherein the adsorbed nanoparticle coating is formed on the oxide.

10. The method of claim 1, wherein the first nanoparticles and the second nanoparticles comprise Ag.

11. The method of claim 1, further comprising:
a) contacting the nanoparticle coated surface of the substrate with an aqueous solution comprising nanoparticles having positively charged moieties on a surface thereof and nanoparticles having negatively charged moieties on a surface thereof;
b) adsorbing the nanoparticles onto the nanoparticle coated surface to form an adsorbed nanoparticle coating on the nanoparticle coated surface; and
c) optionally, repeating steps a) and b) one or more times to form a substrate coated with multiple nanoparticle coating layers.

12. The method of claim 1, wherein: the first nanoparticles and the second nanoparticles each have a diameter of 100 nm or less; or wherein the first nanoparticles and the second nanoparticles each have a diameter of 10 nm or less.

13. The method of claim 1, wherein the first nanoparticles and the second nanoparticles have different diameters.

14. The method of claim 1, wherein the pH of the aqueous solution is from 4 to 10.

15. The method of claim 1, wherein the pH of the aqueous solution is from 6 to 8.

16. The method of claim 1, wherein the pH of the aqueous solution is from 6.9 to 7.1.

17. The method of claim 1, wherein the positively charged moieties comprise a self-assembled monolayer of N,N,N-trimethyl(11-mercaptoundecyl)-ammonium chloride.

18. The method of claim 1, wherein the ratio of positively charged nanoparticles to negatively charged nanoparticles in the aqueous solution is from 0.9:1 to 1.1:1.

19. The method of claim 1, wherein the ratio of positively charged nanoparticles to negatively charged nanoparticles in the aqueous solution is less than or greater than 1:1.

20. The method of claim 1, wherein the substrate is planar, non-planar, corrugated, curved, enclosed, or wherein the substrate has sections having a negative slope to the surface.

21. An article of manufacture made by the method of claim 1.

22. An article of manufacture comprising:
a substrate comprising a surface; and
one or more nanoparticle monolayers on the surface of the substrate,
wherein the one or more nanoparticle monolayers each comprise first nanoparticles having positively charged moieties on a surface thereof and second nanoparticles having negatively charged moieties on a surface thereof and wherein the first and second nanoparticles are adsorbed onto the surface of the substrate.

23. The article of manufacture of claim 22, wherein the surface of the substrate comprises an oxide and wherein the one or more nanoparticle monolayers are on the oxide.

24. The article of manufacture of claim 22, wherein the first nanoparticles and the second nanoparticles comprise a metal.

25. The article of manufacture of claim 22, wherein the first nanoparticles and the second nanoparticles each comprise the same or different metals.

26. The article of manufacture of claim 22, wherein the first nanoparticles and the second nanoparticles each independently comprise a metal selected from the group consisting of Au, Ag, Pt, Cu and Pd.

27. The article of manufacture of claim 22, wherein the positively charged moieties comprise a moiety selected from the group consisting of: a positively charged alkyl-thiol moiety, a positively charged aryl-thiol moiety, a positively charged C₆-C₁₆ n-alkyl thiol moiety and N,N,N-trimethyl(11-mercapto-undecyl)-ammonium chloride.

28. The article of manufacture of claim 22, wherein the negatively charged moieties comprise a moiety selected from the group consisting of: a negatively charged alkyl-thiol moiety, a negatively charged aryl-thiol moiety, a negatively charged C₆-C₁₆ n-alkyl thiol moiety and mercapto undecanoic acid.

29. The article of manufacture of claim 22, wherein the substrate comprises a material selected from the group consisting of a glass, a polymer, silicon, GaAs and tin doped Indium Oxide (ITO).

30. The article of manufacture of claim 22, wherein the substrate comprises a material selected from the group consisting of borosilicate glass, poly(dimethyl siloxane), polystyrene, polyethylene, and poly(methyl methacrylate).

31. The article of manufacture of claim 22, wherein the first nanoparticles and the second nanoparticles comprise Ag.

32. The article of manufacture of claim 22, wherein: the first nanoparticles and the second nanoparticles each have a diameter of 100 nm or less; or wherein the first nanoparticles and the second nanoparticles each have a diameter of 10 nm or less.

33. The article of manufacture of claim 22, wherein the first nanoparticles and the second nanoparticles have different diameters.

34. The article of manufacture of claim 22, wherein the positively charged moieties comprise a self-assembled monolayer of N,N,N-trimethyl(11-mercaptoundecyl)-ammonium chloride on the first metal nanoparticle.

35. The article of manufacture of claim 22, wherein the ratio of positively charged nanoparticles to negatively charged nanoparticles in each monolayer is from 0.9 to 1.1:1.

36. The article of manufacture of claim 22, wherein the substrate is planar, non-planar, corrugated, curved, enclosed, or wherein the substrate has sections having a negative slope to the surface.
